(19) United States
(12) Patent Application Publication
(10) Pub. No.: US 2015/0066556 A1
(43) Pub. Date: Mar. 5, 2015

(54) SYSTEM AND METHOD FOR AN ELECTRONIC DOCUMENT MANAGEMENT AND REVIEW TOOL FOR LITIGATION MATTERS

(71) Applicants: Steve Dominick, Richmond, VA (US); Michael Olszewski, Centreville, VA (US); Paul Walkinshaw, Leesburg, VA (US); James Knaack, Arlington, VA (US)

(72) Inventors: Steve Dominick, Richmond, VA (US); Michael Olszewski, Centreville, VA (US); Paul Walkinshaw, Leesburg, VA (US); James Knaack, Arlington, VA (US)

(21) Appl. No.: 14/472,950

(22) Filed: Aug. 29, 2014

Related U.S. Application Data
(60) Provisional application No. 61/871,734, filed on Aug. 29, 2013.

(51) Int. Cl. G06Q 10/06; G06F 3/0482; G06F 3/0484; G06Q 50/18; G06F 17/30

(52) U.S. Cl. CPC G06Q 10/063114; G06Q 50/18; G06F 17/30126; G06F 3/04842; G06F 3/0482
USPC 705/7.15

(57) ABSTRACT

A system and method for an online, file-sharing system designed to serve as a communication portal between attorneys and their clients, insurance industry contacts, expert witnesses, and any other audience that needs secure connection to the case materials. The system allows for the uploading and review of litigation materials, customizable access controls for record-sharing and data access, total case management, intra-user communications mechanisms, and case-specific alerts.

### REFERENCE TO RELATED APPLICATION

This application claims priority to U.S. Patent App. No. 61/871,734 filed Aug. 29, 2013, which is incorporated herein by reference in its entirety.

### BACKGROUND OF THE INVENTION

1. Field of the Invention

The present invention relates to the field of electronic document management and review tool for litigation matters. More specifically, the invention relates to a system and method for an online, file-sharing system designed to serve as a communication portal between attorneys and their clients, insurance industry contacts, expert witnesses, and any other audience that needs secure connection to the case materials.

2. Description of the Related Art

Document management and review for a litigation matter commonly involves creating binders with paper copies of documents and materials so that lawyers and experts can review accordingly. However, in recent years law firms are now using software that allows them to scan those documents and make them available on the internet so users can view them in remote locations. However, none of these prior systems have integrated all the tools and resources required for efficient management and sharing of documents during discovery in litigation matters. The present invention not only allows for uploading and reviewing litigation materials through the internet, but allows for customizable access controls for record-sharing and data access, total case management, intra-user communications, case-specific alerts, document rules and other unique features not found in the prior art.

### SUMMARY OF THE INVENTION

This summary of the invention is provided to introduce concepts in a simplified form that are further described in the detailed description of the invention. This summary is not intended to identify key or essential inventive concepts of the claimed subject.

The present invention provides an online file-sharing system designed to serve as a communication portal between attorneys and their clients, insurance industry contacts, expert witnesses, and any other audience that needs secure connection to the case materials. Such system may be cloud based and hosted remotely or could be hosted by the client, the insurance industry individuals, or third-party administrators.

The system of the present invention can be accessed through a dynamic secure and password-protected portal via a server, such as a private server, or a cloud-based server. The present invention allows for the uploading of materials that can be reviewed and commented upon by pre-selected users that have been given access to the materials by a system administrator user. Additionally, the present inventions facilitates internal communication between users as well as the ability to provide other pertinent information related to a case, such as a case calendar, tasks, deadlines, reminders, and auto-notifications when items are due, or have been uploaded in compliance with the deadline.

Further, the present invention provides an information sharing, tracking, and task generation system with restricted access comprising: at least one server connected to at least one memory device wherein the at least one memory device has at least one database and, wherein the server is remotely accessible by at least one user; the at least one server having at least one software application resident on the server, wherein the at least one software application is configured to; provide a graphical interface enabling an administrator to add at least one digital legal case; provide a graphical interface enabling an administrator to select a plurality of users from the at least one database to have access to the at least one digital legal case, wherein the users have a category type; provide a graphical interface enabling the administrator to upload at least one file and to identify at least one file category type associated with a file; restricting access to the at least one file based upon the user category type and the file category type; tracking access of the at least one file from each user from the plurality of users granted access; providing a file review interface for the plurality of users granted access to review the at least one file; tracking review progress within the at least one file from each user from the plurality of users and creating bookmarks for a user related to the user's progress with the at least one file; and providing a graphical function on the file review interface enabling each of the plurality of users to select a portion of the file and create a task and assign the task to at least one user. Upon task creation a notification is sent to at least one user which may be an administrator, an attorney, an expert witness, or the user assigned the task. The task creation may be the highlighting or selection of text within a text based file. If the file contains an image the task may be generated by selection an image or a portion of the image. The system is ideally suited for lawyers interacting with their clients and expert witnesses such as medical expert witnesses. The files are often legal files such as legal briefs, file memorandums, a formal legal complaint, a response of answer, and other legal files. The files may also be case related such as with a medical malpractice suit it might contain medical files such as medical records, images, and expert reports.

The present invention also provides a method for sharing and tracking information and access to the information with in file task generation comprising the steps of: enabling an administrator to add at least one digital legal case; selecting a plurality of users from at least one database to have access to the at least one digital legal case, wherein the users have a category type; uploading at least one file and assigning at least one file category type with the file; restricting access to the at least one file based upon the user category type and the file category type; tracking access of the at least one file from each user from the plurality of users granted access; providing a file review interface for the plurality of users granted access to review the at least one file; tracking review progress within the at least one file from each user from the plurality of users and creating bookmarks for a user related to the user's progress with the at least one file; and creating a task from a user initiated selection of a portion of the file; and assigning the task to at least one user. Further steps could comprise creating and sending a notification to at least one user. The notification could be sent to an administrator or to the user assigned the task. The task creation for files containing text could be initiated by selecting or highlighting a portion of text within the file. For files with images with task could be created by selecting an image or a region within the image.

These and other objects, features, and/or advantages may accrue from various aspects of embodiments of the present invention, as described in more detail below.

### BRIEF DESCRIPTION OF THE DRAWINGS

The foregoing summary, as well as the following detailed description of the invention, is better understood when read in conjunction with the appended drawing. For the purpose of illustrating the invention, exemplary constructions of the invention are shown in the drawings. However, the invention is not limited to the specific methods and instrumentalities disclosed herein.

FIG. 1 exemplarily illustrates a flow diagram of the present invention.

FIG. 2A is an illustration of a graphical user interface showing the system administrator user panel.

FIG. 2B is an illustration of a graphical user interface used to create a new case.

FIG. 2C is an illustration of a graphical user interface used to add users to case file.

FIG. 2D is an illustration of a graphical user interface used to create new users.

FIG. 3 is an illustration of a graphical user interface used to upload case documents.

FIG. 4A is an illustration of a graphical user interface used by an administrative user showing the organization of case-specific materials to create “virtual binder” sub-sets.

FIG. 4B is an illustration of a graphical user interface for the non-administrative user showing the organization of case-specific materials within the “virtual binder” sub-sets.

### DETAILED DESCRIPTION OF EXEMPLARY EMBODIMENTS

Particular embodiments of the present invention will now be described in greater detail with reference to the figures.

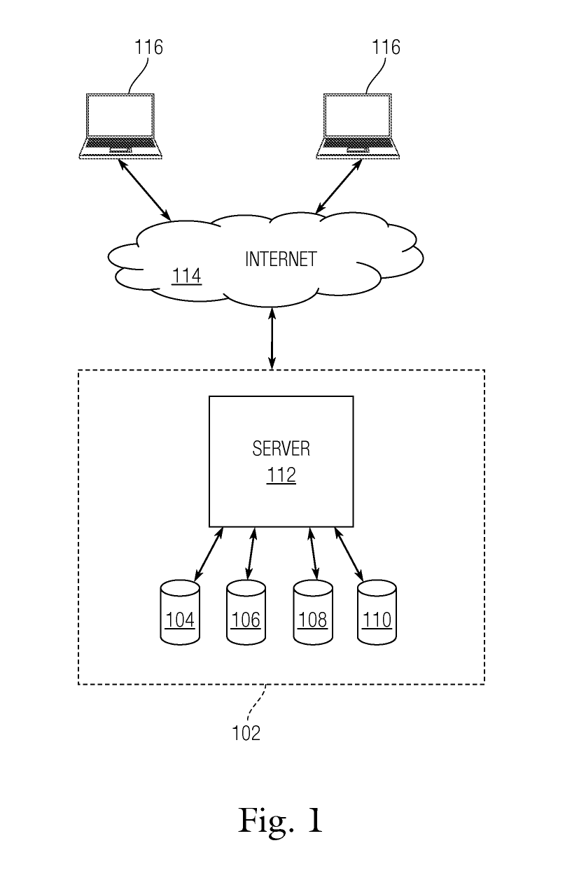

As shown in FIG. 1, the present invention provides for a main system 102 which comprises of one or more servers 112 connected to one or more databases 104, 106, 108, 110.

The databases 104, 106, 108, 110 of the main system 102 are comprised of: (1) one or more databases or tables 104 used to store information related to a legal case (hereinafter referred to as the “case information database”); (2) one or more databases or tables 106 used to store documents and materials related to a legal case (hereinafter referred to as the “document database”); (3) one or more databases or tables 108 used to store information related to user information (hereinafter referred to as the “user information database”); and (4) one or more databases or tables 110 used to store information related to third-party contact information (hereinafter referred to as the “third-party contact information database”). The system may incorporate or utilize additional databases or tables.

Various applications, software, and programs reside on the one or more servers 112 which interact with the processors and databases and allow the user to access the system's web interface, the system administrator application, the document upload application, the document review application, the notification application, and the user profile application. A user may remotely access the system 102 and the applications residing on the server 112 through the internet 114 using the user's remote processor-based device 116. The processor based device 116 may be a laptop, desktop, tablet, or portable computing device.

The system 102 of the present invention may only be accessed through a dynamic secure and password-protected portal. Users are given unique credentials that grant them access to case-specific materials that are applicable to them, as established or determined by the system administrator user, reserving only full access to the system administrator user. Therefore, the system is secure for use by multiple individuals from a variety of audiences, such as attorneys, clients, insurance companies, and experts. Additionally, the system is designed to protect private health information contained in the system, per HIPAA and state-specific medical records privacy laws, as well as attorney-client privileged communications.

The system administrator application allows a system administrator user to customize what documents and records will be shared with each audience (i.e., clients and insurance companies see different materials than select medical experts), thus allowing the ultimate control of access to specific data or outbound data. This customizable access can be modified in real-time and instantly updated, should the system administrator user decide that an additional audience needs to see or access additional information at that time.

Additionally, the system allows for on-the-fly modification of the records in the system, as well as real-time modification of how specific users see the case information and documents available, such as but limited to what documents they have access to, what order the documents will be organized in, which sub-category folder the document will be located in, and at what time or period of time will the materials will be available. The system also has the ability to keep track of user access of each item on the server, when accessed, and whether any modifications were made to the case data, such as when documents were uploaded, modified, and removed.

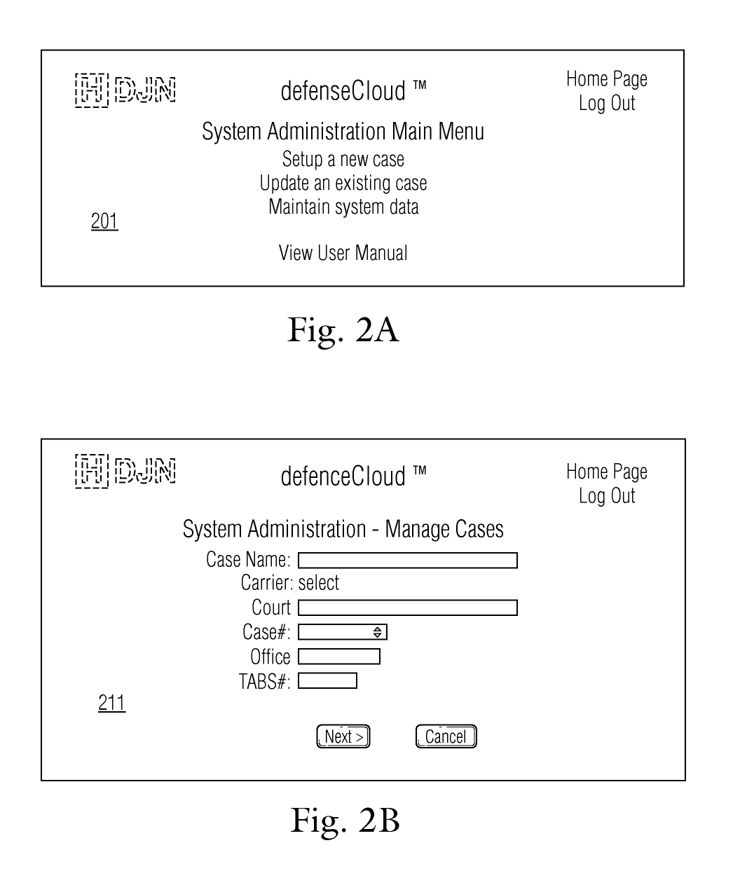

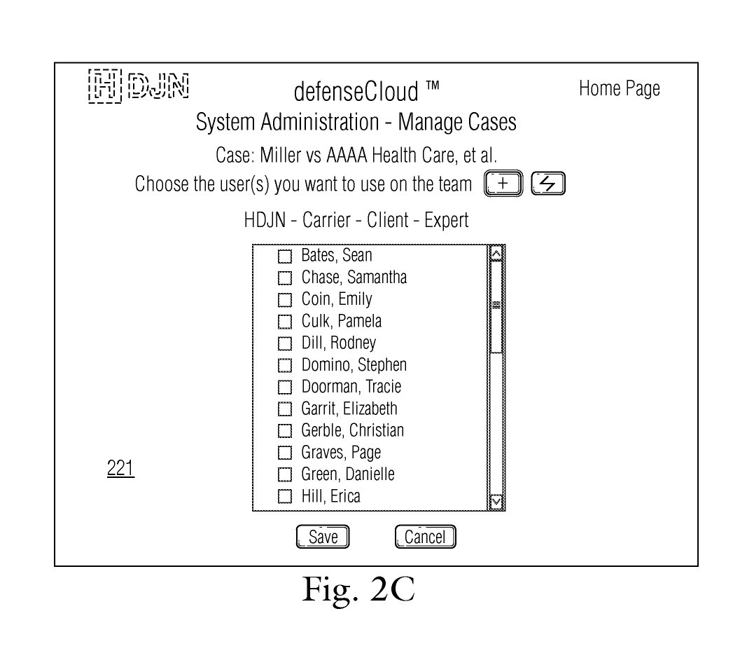

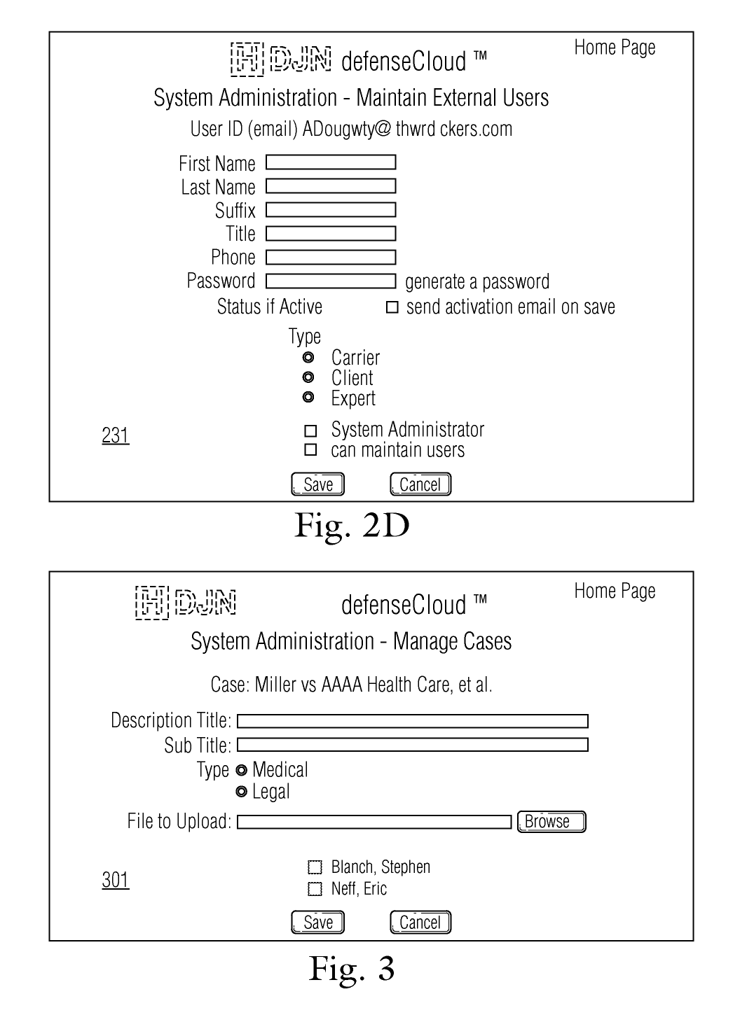

As shown in FIG. 2A, the system administrator application provides a graphical user interface 201 which allows a system administrator user to create, update, and maintain new cases by uploading case materials, documents and information to the system. By way of example, to set up a new case, the system administrator user inputs case information into pre-determined fields including, but not limited to “Case Name”, “Client Name”, “Court”, “Case Number”, “Office”, and “TABS Number” as depicted in user interface 211 as seen in FIG. 2B. From there, the administrative user can add users to the case file. These users can be selected from a pre-existing list or entered manually to create a new user as depicted in interface 221 as seen in FIG. 2C. Users can be clients, insurance industry contacts, expert witnesses, lawyers, and any other audience. The pre-existing list of users can be broken down into several sub-categories such as legal team, client/carrier, and expert.

As shown in FIG. 2D, interface 231 enables new users to be entered manually and added to the pre-existing sub-categories by entering several pieces of information into fields, including but not limited to “email”, “First Name”, “Last Name”, “Suffix”, “Title”, “Phone”, “Password”. Additionally, system administrator user can designate users as a “system administrator” or “can maintain user” status, as well as make them “active” or “inactive” users.

Once the pertinent case information and initial user information is entered into the system, the system administrator user, through the document upload application, can upload case documents that correspond with a specific case. By way of example, as seen in the graphical user interface 301, the system administrator user selects a case document from his computer, using the browse function, and enters relevant information about the document into pre-determined fields such as “Description/Title”, “Sub-title”, “Type” and designates access limitations as depicted in FIG. 3. Through the access limitations, a system administrator user can select which users assigned to the case have access to which documents. For example, the system administrator user may only grant medical experts assigned to the case access to medical records. Once the required fields are filled, the system administrator user can upload the document to the system's server. This process can be repeated several times until all the documents and materials that are a part of a case are uploaded into the system. Materials can be uploaded or deleted from the system at anytime and access limitations to those materials be changed at anytime as well.

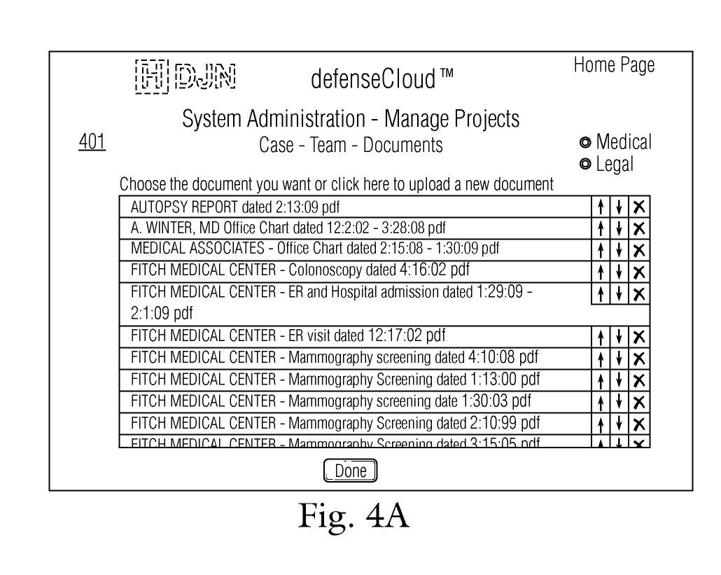

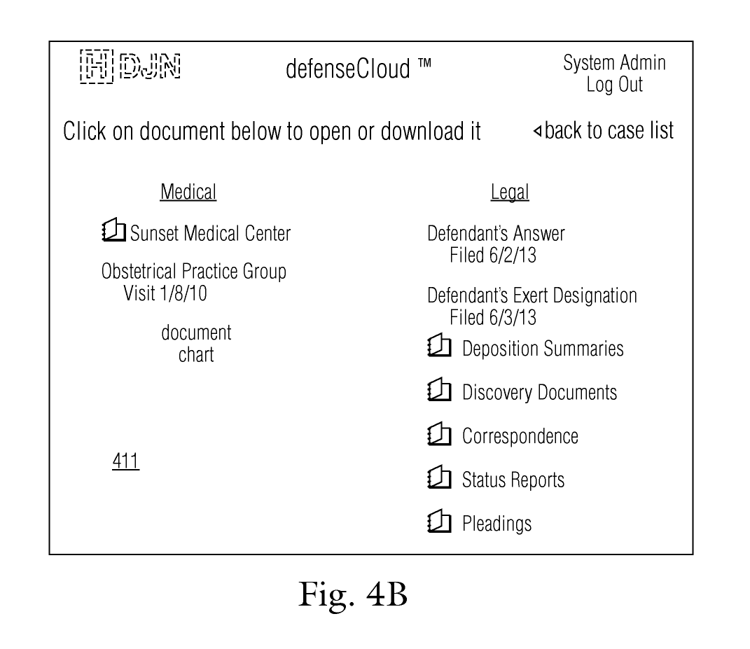

As shown in graphical user interfaces 401 and 411 as seen in FIGS. 4A & 4B, the system administrator application allows a system administrator user to organize and sort case-specific materials and create sub-sets, such as “virtual binders,” allowing for a more customizable delivery of files to the users in a way that best suits the user or admin user. Additionally, the system has the ability to allow the administrator user to determine what categories of documents they organize and share with the other user groups. By way of example, the system administrator user, via the system's sub-level organization mechanism, can arrange all medical records into a medical record folder, all emails and letters into a correspondence folder, and so forth and so on. These folders can have access restrictions so that the system administrator user can control which users have access to each folder and each document.

The system administrator application also allows for the system administrator user to update existing cases. This feature allows the system administrator user to update team member users, upload or delete documents, update case information, and case notifications.

The system administrator application also allows for the system administrator user to maintain system data. Data such as names and contact information for carriers/clients, external users, and law firm users can be created, changed, and removed from the system in real-time by the system administrator user.

The system administrator application also allows for the system administrator user to provide a case calendar with deadlines, reminders, and auto-notifications when items are due, or have been uploaded in compliance with an impending deadline. Additionally, the system allows the system administrator user to add a case “bulletin board” to the case file where users can post items to internally communicate with each other regarding items added, items needed, or any other form of communication the users wish to post. All the interactions may be tracked by the system and can be reviewed by the system administrator user.

The document upload application also allows for non-system administrative users who have been granted authority to upload case-specific materials to the system. The system administrator user can elect to review and approve all documents uploaded by non-system administrative users before they are made available to other users in the system.

The document review application allows for users to review documents and comment on documents uploaded into the system. These materials may be in multiple formats and can be viewed within the system's viewer or opened up in the format's native viewer, e.g., presentations can be opened up in the system's presentation viewer or PowerPoint.

Additionally, the system allows users to flag, highlight, or bookmark entire documents or portions of documents for future reference. Any flagging, highlighting and bookmarking may be recorded by the system and may be produced in a report for future reference. That report, along with the flagging, highlighting and bookmarking may be viewed by only the user, the system administrator user, or both.

The system also allows for commenting on documents, cross-reference to other documents. These comments and cross-references may be recorded by the system and produced as a report for future viewing by the user, the system administrator user, or both. This report may be customizable and allow the user to organize his or her comments in a manner most suitable to his or her liking.

The document review application also allows for the creation of tasks based upon a user's review of the materials. By way of example, a user who is a medical expert could be examining medical records and notice that the doctor prescribed a medicine that is not commonly prescribed for the type of injury inflicted. To conduct further research on the prescribed medicine, he could highlight that portion of the document and create a research task for himself or another user of the case to conduct. This task will be logged into the system and the notification application will then notify the user, the user assigned with the task, and/or the system administrator user of the creation, completion and impending deadline of the task.

The user profile application allows for a non-system administrator user to modify his contact information, review a list of documents he has examined, and review his comments, tasks, or any other user generated data. Additionally through the user profile application, the user can conduct other activities permitted by the system administrator user, such as upload documents, create new cases, and so forth.

The notification application allow for the system administrator user to set up an auto-notifications for users regarding case-specific information. For example, the system may auto-notify non-system administrator users of their addition to the user list for a case and how to access the system. Further, the system is able to allow system administrators to set the system to auto-notify other users whenever a new document (or set of documents) has been added, when a change in the case status or information occurs, or when comments/notes have been added to case materials. All notifications are recorded within the system for future reference.

The system also enables users to communicate internally and externally with each other. The system has the ability to act as both an internal communication portal between users on a particular file/case, or to communicate directly from the system to the other users' outside e-mail and/or text-message address. All case-related communications may be captured by the system, logged, and stored in the system for future reference.

The system also may include a self-contained research tool for finding previously-used experts, previously represented parties, insurance industry contacts, and any other user-based data. For example, if a user is handling a medical malpractice lawsuit, he or she can search the third-party contact information database 110 for medical experts that have been used in the past, documents that have been filed in the past in medical malpractice lawsuits, and contact information for other third parties relevant to the case.

The described embodiments may be implemented as a system, method, apparatus or article of manufacture using standard programming and/or engineering techniques related to software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

The systems and methods described herein may use networks, wherein, the term, ‘networks’ means a system allowing interaction between two or more electronic devices, and includes any form of inter/intra enterprise environment such as the world wide web, Local Area Network (LAN), Wide Area Network (WAN), Storage Area Network (SAN) or any form of Intranet.

The systems and methods of the embodiment described herein can be practiced using any electronic device. An electronic device for the purpose of this invention is selected from any device capable of processing or representing data to a user and providing access to a network or any system similar to the internet, wherein the electronic device may be selected from but not limited to, personal computers, mobile phones, laptops, palmtops, portable media players and personal digital assistants.

The examples provided herein are merely for the purpose of explanation and are in no way to be construed as limiting of the present method and product disclosed herein. While the invention has been described with reference to various embodiments, it is understood that the words which have been used herein are words of description and illustration, rather than words of limitation. Further, although the invention has been described herein with reference to particular means, materials, and embodiments, the invention is not intended to be limited to the particulars disclosed herein; rather, the invention expands to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

We claim:

1. An information sharing, tracking, and task generation system with segmented access comprising:
a. at least one server connected to at least one memory device wherein the at least one memory device has at least one database and, wherein the server is remotely accessible by at least one user;
b. the at least one server having at least one software application resident on the server, wherein the at least one software application is configured to;
c. provide a graphical interface enabling an administrator to add at least one digital legal case;
d. provide a graphical interface enabling an administrator to select a plurality of users from the at least one database to have access to the at least one digital legal case, wherein the users have a category type;
e. provide a graphical interface enabling the administrator to upload at least one file and to identify at least one file category type associated with a file;
f. restricting access to the at least one file based upon the user category type and the file category type;
g. tracking access of the at least one file from each user from the plurality of users granted access;
h. providing a file review interface for the plurality of users granted access to review the at least one file;
i. tracking review progress within the at least one file from each user from the plurality of users and creating bookmarks for a user related to the user's progress with the at least one file; and
j. providing a graphical function on the file review interface enabling each of the plurality of users to select a portion of the file and create a task and assign the task to at least one user.

2. The system of claim 1, wherein upon task creation a notification is sent to at least one user.

3. The system of claim 2, wherein the notification is sent to an administrator.

4. The system of claim 2, wherein the notification is sent to the user assigned the task.

5. The system of claim 1, wherein the file contains text and the selection of a portion of the file to create a task entails highlighting a portion of text within the file.

6. The system of claim 1, wherein the file contains an image and the selection of a portion of the file to create a task entails selecting a region within the image.

7. The system of claim 1, wherein the at least one of the plurality of users is a lawyer.

8. The system of claim 1, wherein the at least one of the plurality of users is an expert witness.

9. The system of claim 1, wherein the at least one of the plurality of users is a client.

10. The system of claim 1, wherein the at least one user category is a lawyer.

11. The system of claim 1, wherein the at least one file category type is a legal file.

12. The system of claim 1, wherein the at least one file category type is a medical file.

13. A method for sharing and tracking information access with in file task generation comprising the steps of:
k. enabling an administrator to add at least one digital legal case;
l. selecting a plurality of users from at least one database to have access to the at least one digital legal case, wherein the users have a category type;
m. uploading at least one file and assigning at least one file category type with the file;
n. restricting access to the at least one file based upon the user category type and the file category type;
o. tracking access of the at least one file from each user from the plurality of users granted access;
p. providing a file review interface for the plurality of users granted access to review the at least one file;
q. tracking review progress within the at least one file from each user from the plurality of users and creating bookmarks for a user related to the user's progress with the at least one file; and
r. creating a task from a user initiated selection of a portion of the file; and
s. assigning the task to at least one user.

14. The method of claim 13, further comprising the step of creating and sending a notification to at least one user.

15. The method of claim 14, wherein the notification is sent to an administrator.

16. The method of claim 14, wherein the notification is sent to the user assigned the task.

17. The method of claim 13, wherein the file contains text and the selection of a portion of the file to create a task entails highlighting a portion of text within the file.

18. The method of claim 13, wherein the file contains an image and the selection of a portion of the file to create a task entails selecting a region within the image.
